(19) United States
(12) Patent Application Publication
(10) Pub. No.: US 2025/0087780 A1
(43) Pub. Date: Mar. 13, 2025

(54) BATTERY PACK OF VEHICLE

(71) Applicants: HYUNDAI MOTOR COMPANY, SEOUL (KR); KIA CORPORATION, SEOUL (KR)

(72) Inventors: Yong Gyu Lee, Hwaseong-si (KR); Sung Min Hong, Hwaseong-si (KR)

(73) Assignees: HYUNDAI MOTOR COMPANY, SEOUL (KR); KIA CORPORATION, SEOUL (KR)

(21) Appl. No.: 18/823,959

(22) Filed: Sep. 4, 2024

(30) Foreign Application Priority Data
Sep. 7, 2023 (KR) 10-2023-0119192
Aug. 14, 2024 (KR) 10-2024-0109135

(51) Int. Cl. H01M 10/613; H01M 10/625; H01M 10/6568; H01M 10/667; H01M 50/505

(52) U.S. Cl. CPC H01M 10/613; H01M 10/625; H01M 10/6568; H01M 10/667; H01M 50/505

(57) ABSTRACT

A battery pack of a vehicle includes a plurality of battery modules, and a first cooling jacket in which a flow path through which a cooling medium flows is internally formed. Each of the plurality of battery modules may include a battery, a power conversion module converting power of the battery, and a busbar connecting the battery and the power conversion module, and the busbar may be in close contact with the first cooling jacket and may be formed integrally with the first cooling jacket.

### CROSS REFERENCE TO RELATED APPLICATIONS

This application claims benefit of priority to Korean Patent Application Nos. 10-2023-0119192 filed on Sep. 7, 2023 and 10-2024-0109135 filed on Aug. 14, 2024, in the Korean Intellectual Property Office, the disclosures of which are incorporated herein by reference in their entirety.

### BACKGROUND

### 1. Field

The present disclosure relates to a battery pack of vehicle.

### 2. Description of Related Art

In general, eco-friendly vehicles include a battery pack having a plurality of batteries and a power conversion module (e.g., an inverter or a converter). Thereamong, the battery pack and the power conversion module are connected via a busbar. The busbar is commonly formed of copper, and this busbar is commonly cooled by air cooling.

Recently, due to an increase in the output power of eco-friendly vehicles, a cross-sectional area of the busbar needs to be increased, and accordingly, the weight and costs of the busbar also increase. Additionally, due to the increase in the output power of the eco-friendly vehicles, a higher current flows through the busbar than before, the cooling performance cannot be improved by the conventional air-cooling method.

Meanwhile, each of the battery pack and the power conversion module occupies separate spaces, and accordingly, cooling devices for providing coolant to each of the battery pack and the power conversion module are also installed separately, and the components for connecting the battery pack and the power conversion module are significantly complexly configured.

Additionally, cooling of both the battery and the power conversion module is required when driving an eco-friendly vehicle, and cooling of the power conversion module is not required during charging. Accordingly, when the cooling capability of the power conversion module can be converted to the cooling capability of the battery during charging, it may be possible to focus on cooling the battery, thereby increasing the charging speed and ensuring stability.

However, in the case of the structure of the existing cooling device, cooling devices are installed separately for the battery pack and the power conversion module, and the respective cooling device operate independently, and accordingly, it may be impossible to focus on cooling the battery, so that during charging, the charging speed may not increase and stability thereof may not be ensured.

### SUMMARY

An aspect of the present disclosure is to provide a battery pack of a vehicle that may improve the cooling performance of a busbar, from which a cross-sectional area of the busbar may be reduced to reduce the costs and weight of the busbar.

An aspect of the present disclosure is to provide a battery pack for a vehicle to improve the cooling performance of a battery and a power conversion module.

An aspect of the present disclosure is to provide a battery pack for a vehicle that may simplify a cooling structure and focus on cooling the battery during charging, thereby ensuring charging speed and stability while reducing costs.

An aspect of the present disclosure is to provide a battery pack for a vehicle that may differentially control the cooling performance of a power conversion module and a battery.

According to an embodiment of the present disclosure, provided is a battery pack of a vehicle including a plurality of battery modules, and a first cooling jacket in which a flow path through which a cooling medium flows is internally formed, and each of the plurality of battery modules may include a battery, a power conversion module converting power of the battery, and a busbar connecting the battery and the power conversion module, and the busbar may be in close contact with the first cooling jacket and is formed integrally with the first cooling jacket.

According to an embodiment of the present disclosure, the first cooling jacket may be provided with an opening through which the busbar passes, and the busbar may be in close contact with at least one of a side surface of the opening and an upper surface of the first cooling jacket.

According to an embodiment of the present disclosure, the busbar may be in close contact with the side surface of the opening, may extend along the side surface of the opening, and may then be bent to closely contact the upper surface of the first cooling jacket.

According to an embodiment of the present disclosure, the busbar may include a conductor, an insulating medium for insulating the conductor, and at least one of the insulating medium and side surface of the opening, and the insulating medium and side surface of the first cooling jacket may be in close contact with each other via a heat transfer medium.

According to an embodiment of the present disclosure, the power conversion module may be in close contact with one surface of the first cooling jacket, and the battery may be in close contact with the other surface of the first cooling jacket.

According to an embodiment of the present disclosure, the battery pack of a vehicle further include a second cooling jacket which is in close contact with the lower surfaces of the plurality of battery modules and in which a flow path through which the cooling medium flows is internally formed.

According to an embodiment of the present disclosure, the battery and the first cooling jacket, the first cooling jacket and the power conversion module, and the second cooling jacket and the plurality of battery modules are in close contact with each other via a heat transfer medium.

According to an embodiment of the present disclosure, a flow rate of the cooling medium flowing through the flow path formed in the second cooling jacket and a flow rate of the cooling medium flowing through the flow path formed in the first cooling jacket may be independently controllable.

According to an embodiment of the present disclosure, the power conversion module may include at least one of a DC/DC converter and a DC/AC inverter.

According to an embodiment of the present disclosure, provided is a battery pack of a vehicle including a plurality of battery modules, a first cooling jacket in which a flow path through which a cooling medium flows is internally formed, and a second cooling jacket in which a flow path through which the cooling medium flows is internally formed, wherein each of the plurality of battery modules includes a battery, a power conversion module for converting power of the battery, and a busbar connecting the battery and the power conversion module, and the first cooling jacket may be provided with an opening through which the busbar passes, the busbar may be in close contact with a side surface of the opening and an upper surface of the first cooling jacket, the power conversion module may be in close contact with one surface of the first cooling jacket, and the battery may be in close contact with the other surface of the first cooling jacket, and the plurality of battery modules may be in close contact with an upper surface of the second cooling jacket.

According to an embodiment of the present disclosure, while additionally configuring a first cooling jacket in a battery module including a battery, a power conversion module, and a busbar, and the busbar may be integrally formed by coming into close contact with the first cooling jacket to improve the cooling performance of the busbar, through which a cross-sectional area of the busbar may be reduced, thereby reducing the costs and weight of the busbar.

Additionally, according to an embodiment of the present disclosure, a first cooling jacket may be added into a battery pack, and the power conversion module and the battery may be in close contact with one side and the other side of the first cooling jacket, respectively, thereby improving the cooling performance of the battery and the power conversion module.

Additionally, according to an embodiment of the present disclosure, power conversion modules such as an inverter or a converter may be collected into a battery pack and a cooling jacket for cooling the power conversion modules may be disposed in the battery pack, so that the cooling structure may be simplified, and the cooling of the battery may be focused on during charging, thereby securing the charging speed and stability, and reducing the costs.

Additionally, according to an embodiment of the present disclosure, thermal resistance between the first cooling jacket and the battery may be configured to be smaller than thermal resistance between the first cooling jacket and the power conversion module, or a flow rate of a cooling medium flowing through a flow path formed in the second cooling jacket and a flow rate of a cooling medium flowing through a flow path formed in a first cooling jacket may be independently controlled, thereby differentially controlling the cooling performance of the power conversion module and the battery.

### BRIEF DESCRIPTION OF THE FIGURES

The above and other aspects, features, and advantages of the present disclosure will be more clearly understood from the following detailed description, taken in conjunction with the accompanying drawings, in which:

FIG. 1 is a perspective view of a battery pack of a vehicle according to an embodiment of the present disclosure;

FIG. 2A is a view of the battery pack illustrated in FIG. 1 when viewed from the top;

FIG. 2B is a cutaway view of the battery pack illustrated in FIG. 1 when viewed from the side surface;

FIG. 3A and FIG. 3B are views illustrating a flow path inside a first cooling jacket according to an embodiment of the present disclosure;

FIG. 4 is a view illustrating a busbar coming into close contact with the first cooling jacket and formed integrally therewith according to an embodiment of the present disclosure; and

FIG. 5 is a view exemplarily illustrating a circuit of a battery module according to an embodiment of the present disclosure.

### DETAILED DESCRIPTION

Hereinafter, a specific embodiment of the present disclosure will be described with reference to the drawings. The following detailed description is provided to help gain a comprehensive understanding of methods, devices, and/or systems described herein. However, this is only an example, and the present disclosure is not limited thereto.

In describing example embodiments of the present disclosure in detail, when it is determined that a detailed description of known technologies associated with the present disclosure may unnecessarily obscure the gist of the present disclosure, the detailed description thereof will be omitted. Furthermore, the terms described below are defined in consideration of functions in the present disclosure, and may vary according to the intention or practice of a user or an operator. Therefore, the definition thereof should be based on the content throughout this specification. The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a portion or combinations thereof, and shall not be construed to preclude any presence or possibility of one or more other characteristics, numbers, steps, operations, elements, parts or combinations thereof.

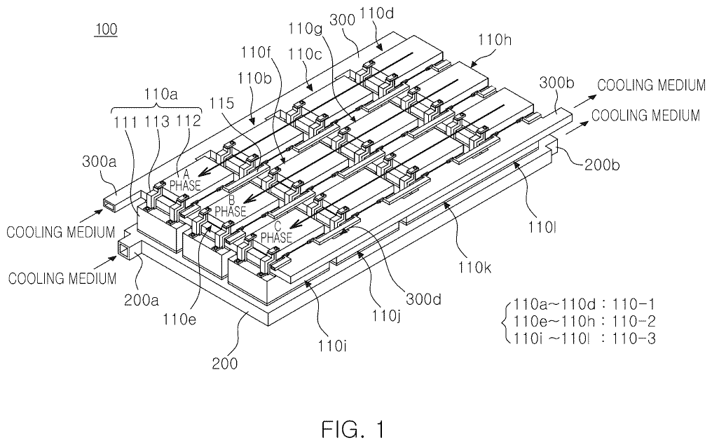

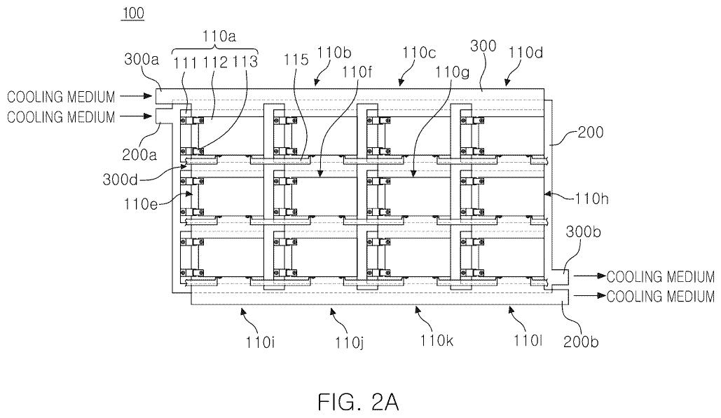

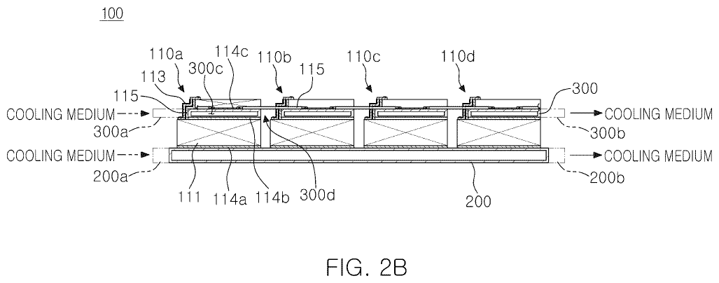

FIG. 1 is a perspective view of a battery pack of a vehicle according to an embodiment of the present disclosure. Additionally, FIG. 2A is a view of the battery pack illustrated in FIG. 1 when viewed from the top, and FIG. 2B is a cutaway view of the battery pack illustrated in FIG. 1 when viewed from the side surface.

As illustrated in FIGS. 1 to 2B, a battery pack 100 of a vehicle according to an embodiment of the present disclosure may include a plurality of battery modules 110a, 110b, 110c, 110d, 110c, 110f, 110g, 110h, 110i, 110j, 110k and 1101, a first cooling jacket 300, and a second cooling jacket 200. Although FIG. 1 illustrates 12 battery modules, this is to help understand the present disclosure, and there may be at least two or more battery modules.

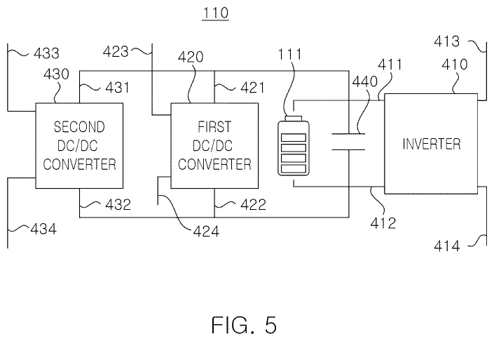

The multiple battery modules 110a, 110b, 110c, 110d, 110e, 110f, 110g, 110h, 110i, 110j, 110k and 1101 may include three single-phase battery module systems 110-1, 110-2 and 110-3. Additionally, the three single-phase battery module systems 110-1, 110-2 and 110-3 may include three-phase (A-phase, B-phase and C-phase) AC system output terminal configured by serially connecting inverter output terminals (see reference numerals 413 and 414 of FIG. 5 described below) through a busbar 115. The three-phase (A-phase, B-phase and C-phase) AC system output terminal may output different AC voltages having the same magnitude and the same phase difference.

For example, the three-phase (A-phase, B-phase and C-phase) AC system output terminal may output different AC voltages having a phase difference of 120 degrees from each other. Accordingly, the three-phase (A-phase, B-phase and C-phase) AC system output terminal may output a three-phase AC voltage, and may provide a driving voltage to a motor using the three-phase AC voltage as a driving voltage.

The busbar 115 described above may be provided on a side surface of the battery module, and the busbar 115 may be in contact with the first cooling jacket 300. However, the present disclosure is not limited thereto, and the busbar 115 may be cooled in an air-cooling manner by being installed apart from the first cooling jacket 300 so as not to come into contact with the first cooling jacket 300.

Each of the plurality of battery modules 110a, 110b, 110c, 110d, 110c, 110f, 110g, 110h, 110i, 110j, 110k and 1101 has the same structure, and thus, hereinafter, the structure of one battery module 110a will be mainly described.

The battery module 110a may include a battery 111, a power conversion module 112 converting power of the battery 111, and a busbar 113.

The second cooling jacket 200 may be in close contact with lower surfaces of the battery modules 110a, 110b, 110c, 110d, 110c, 110f, 110g, 110h, 110i, 110j, 110k and 1101, and a flow path through which a cooling medium flows may be formed therein.

The cooling medium may be introduced through the inlet 200a, may circulate across an entire surface of the second cooling jacket 200 along the flow path formed therein, and may then be discharged through an outlet 200b. Here, the cooling medium may be coolant, but other cooling mediums besides the coolant may also be applied thereto.

Meanwhile, the battery 111 may be in close contact with one surface of the first cooling jacket 300, and the power conversion module 112 may be in close contact with the other surface of the first cooling jacket 300, and a flow path through which a cooling medium flows may be formed in the first cooling jacket 300. Although the drawings illustrate that the battery 111 is in close contact with a lower surface of the first cooling jacket 300, and the power conversion module 112 is in close contact with an upper surface of the first cooling jacket 300, but according to an embodiment, the battery 111 may be in close contact with the upper surface of the first cooling jacket 300, and the power conversion module 112 may be in close contact with the lower surface of the first cooling jacket 300. The cooling medium may be introduced through an inlet 300a, may circulate across the entire surface of the first cooling jacket 300 along the flow path formed therein, and may then be discharged through an outlet 300b.

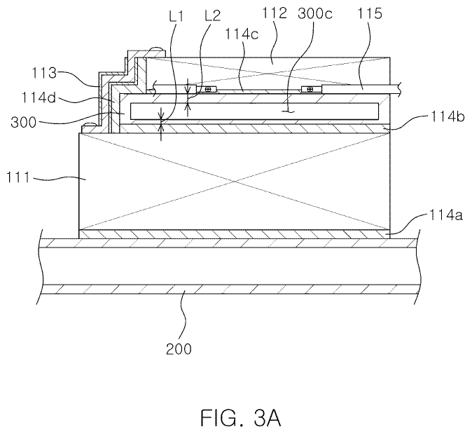

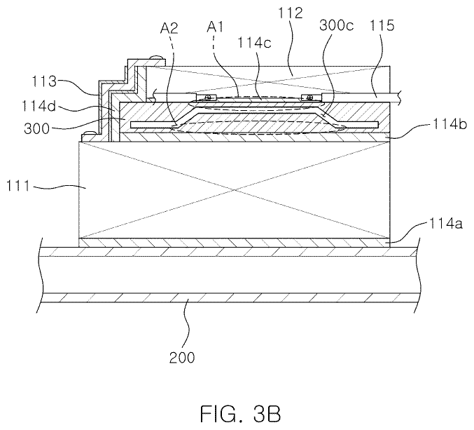

According to an embodiment of the present disclosure, thermal resistance between the first cooling jacket 300 and the battery 111 may be smaller than thermal resistance between the first cooling jacket 300 and the power conversion module 112. To this end, a distance between the flow path formed in the first cooling jacket and the battery may be configured to be shorter than a distance between the flow path formed in the first cooling jacket and the power conversion module, or an area of a flow path adjacent to the power conversion module among the flow paths formed in the first cooling jacket may be configured to be smaller than an area of a flow path adjacent to the battery (see FIGS. 3A and 3B below).

FIGS. 3a and 3b are views illustrating flow paths in a first cooling jacket according to an embodiment of the present disclosure.

Specifically, as illustrated in FIG. 3A, a distance L1 between a flow path 300c formed in a first cooling jacket 300 and a battery 111 may be shorter than a distance L2 between a flow path 300c formed in the first cooling jacket 300 and a power conversion module 112.

Additionally, as illustrated in FIG. 3B, an area A1 of a flow path adjacent to the power conversion module 112 among the flow paths 300c formed in the first cooling jacket 300 may be smaller than an area A2 of a flow path adjacent to the battery 111.

Additionally, thermal resistance of a heat transfer medium 114b provided between the first cooling jacket 300 and the battery 111 may be smaller than thermal resistance of a heat transfer medium 114c provided between the first cooling jacket 300 and the power conversion module 112.

Through this configuration, the cooling performance of the power conversion module and the battery may be differentially controlled.

Meanwhile, the first cooling jacket 300 may be provided with an opening 300d through which a busbar 113 passes, and the busbar 113 may be connected to the battery 111 and the power conversion module 112 through the opening 300d. The busbar 113 may be formed integrally with the first cooling jacket 300.

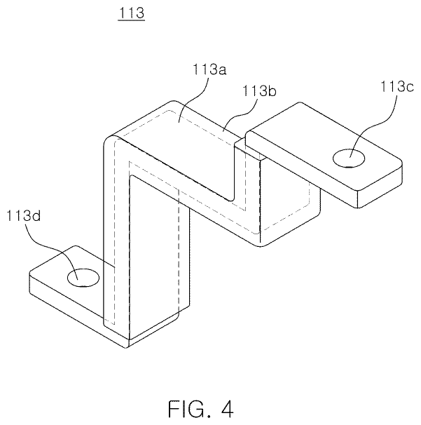

FIG. 4 is a view illustrating a busbar coming into close contact with the first cooling jacket and formed integrally therewith according to an embodiment of the present disclosure.

As illustrated in FIG. 4, the busbar 113 may be comprised of a conductor 113a such as copper, and an insulating medium 113b (e.g., an insulating coating or insulating paper) for insulating the conductor 113a, and one side of the busbar 113 may be screw-fastened to the battery 111 through a groove 113d, and the other side of the busbar 113 may be screw-fastened to the power conversion module 112 through a groove 113c.

According to an embodiment of the present disclosure, the busbar 113 may come into close with the first cooling jacket 300 and may be formed integrally therewith.

As illustrated in FIGS. 3a and 3b, the busbar 113 may be in close contact with a side surface of the opening 300d and may extend along the side surface of the opening 300d and may then be bent to closely contact an upper surface of the first cooling jacket 300. Additionally, side surfaces of the busbar 113 and the opening 300d, and side surfaces of the busbar 113 and the first cooling jacket 300 may be in close contact with each other via a heat transfer medium 114d. Side surfaces of the busbar 113 and the power conversion module 112 may also be in close contact with the heat transfer medium 114d.

Referring again to FIGS. 1 to 3B, the second cooling jacket 200 and the plurality of battery modules 110, 120, 130, 140, 150 and 160, the battery 111 and the first cooling jacket 300, and the first cooling jacket 300 and the power conversion module 112 may be in close contact with each other via heat transfer media 114a, 114b and 114c.

The heat transfer media 114a, 114b, 114c and 114d may be formed of thermal grease or heat transfer pads.

Meanwhile, a flow rate of the cooling medium flowing through the flow path formed in the second cooling jacket 200 and a flow rate of the cooling medium flowing through the flow path formed in the first cooling jacket 300 may be independently controlled. To this end, a valve or a water pump (not illustrated separately) may be installed in an inlet 200a of the second cooling jacket 200 and an inlet 300a of the first cooling jacket 300, respectively, so that the flow rates of the cooling media may be independently controlled. This is only an example of the present disclosure, and it would be obvious that various modifications may be made according to the needs of those skilled in the art. Through the components, the cooling performance of the power conversion module and the battery may be differentially controlled.

Meanwhile, the power conversion module 112 is a device for converting the power of the battery 111, and may include at least one of a DC/DC converter and a DC/AC inverter.

FIG. 5 is a view exemplarily illustrating a circuit of a battery module according to an embodiment of the present disclosure. The circuit illustrated in FIG. 5 is intended to help understand the present disclosure, and it should be noted that the present disclosure is not limited to FIG. 5.

As illustrated in FIG. 5, a battery module 110 may include a battery 111, an inverter 410 connected to the battery 111, a first DC/DC converter 420, and a second DC/DC converter 430. Accordingly, an embodiment of the present disclosure, the battery module 110 may further include a common capacitor 440. The inverter 410, the first DC/DC converter 420 and the second DC/DC converter 430 may correspond to the power conversion module of the present disclosure.

The battery 111 may output a battery voltage and charge or discharge electric energy. Additionally, the battery voltage may form a base voltage of the battery module 110, and may provide input voltages of the inverter 410, the first DC/DC converter 420 and the second DC/DC converter 430.

Additionally, the battery 111 may have a battery voltage having a lower size than a high-voltage battery pack applied to a conventional electric vehicle driving system. Accordingly, the vehicle battery module 110 according to an embodiment of the present disclosure may be subject to a power conversion element configured to be operable at low voltage, thereby reducing manufacturing costs.

According to the battery module 110 according to an embodiment of the present disclosure, various sizes and types of voltages thereof may be output depending on the series/parallel combination of the battery module 110, so that the battery module 110 may be applied to various vehicle models having different specifications using a single standard battery module 110, thereby reducing manufacturing costs.

For example, when the battery voltage is set to 100 V, a battery module system outputting 400 V voltage may be formed by connecting four battery modules 110 in series, and a battery module system outputting 800 V voltage may be formed by connecting eight battery modules 110 in series. Additionally, for example, when the battery voltage is set to 50 V, a battery module system outputting 400 V voltage may be formed by connection eight battery modules 110 in series, and a battery module system outputting 800 V voltage may be formed by connecting 16 battery modules 110 in series.

Additionally, the battery modules 110 may be connected to each other in series, and a single-phase battery module system outputting a high-voltage AC voltage may be formed using an inverter output, and a three-phase AC voltage to be output using a plurality of single-phase battery module systems. Additionally, the battery modules 110 may be combined in parallel to form a battery module system through which a large current flows.

The inverter 410 may convert the battery voltage into an AC module voltage and output the voltage. Additionally, the inverter 410 may include input terminals 411 and 412 and output terminals 413 and 414, and the inverter input terminals 411 and 412 may be connected to the battery 111 in parallel to receive the battery voltage, and the inverter output terminals 413 and 414 may output the AC module voltage. Additionally, in this specification, the inverter output terminals 413 and 414 may be referred to an AC module output terminals outputting the AC module voltage.

Additionally, the first DC/DC converter 420 may convert the battery voltage into a first DC module voltage, lower than the battery voltage, and may output the first DC module voltage. Additionally, the first DC module voltage may be set as a driving voltage of a low-voltage load. For example, the low-voltage load may be various lamps of the electric vehicle and electric loads such as radios, infotainment, and the like. Additionally, the first DC module voltage may be set to 12V, 24V, or 48V, which is the driving voltage of the low-voltage load. However, the voltage size mentioned in this specification is only an embodiment, and may be set to various voltage sizes depending on the design.

Additionally, the first DC/DC converter 420 may include input terminals 421 and 422 and output terminals 423 and 424, and the input terminals 421 and 422 of the first DC/DC converter 420 may be connected to the battery 111 in parallel to receive the battery voltage, and the output terminals 423 and 424 of the first DC/DC converter 420 may output the first DC module voltage. Additionally, in this specification, the output terminal 423 and 424 of the first DC/DC converter 420 may be referred to as first DC module output terminals outputting the first DC module voltage.

Additionally, the output terminal 423 and 424 of the first DC/DC converter 420 may be directly connected to a low-voltage load to provide the first DC module voltage.

In an embodiment, one end of the output terminal 424 of the first DC/DC converter 420 may be grounded, and the other end of the output terminal 23 may be connected to the low-voltage load to output the first DC module voltage. In another embodiment, both ends of the output terminal of the first DC/DC converter 420 may be connected to both ends of the low-voltage load to output the first DC module voltage.

Additionally, the second DC/DC converter 430 may convert the battery voltage into a second DC module voltage and may output the second DC module voltage. The second DC module voltage may be set to a value greater than the first DC module voltage output from the first DC/DC converter 420. Additionally, the second DC module voltage may be less than or equal to the battery voltage, and may be greater than the battery voltage.

Additionally, the second DC module voltage output from the second DC/DC converter 430 may connected in series to a second DC module voltage output from another battery module 110, thus providing power to the high voltage load. In other words, the second DC module voltage output from the second DC/DC converter 430 may not provide power to a high voltage load as a single output power but may be connected in series to the second DC module voltage of another battery module 110 to provide power to the high voltage load. Since the battery voltage included in the battery module 110 is formed as a low voltage, a plurality of battery modules 110 may be coupled to each other in series to provide a high voltage, so as to provide voltage to a high voltage load such as an air conditioning system. In other words, the output terminal of the second DC/DC converter 430 may be connected in series to the output terminal of the second DC/DC converter 430 of another battery module to form a high voltage, thereby providing power to the high voltage load.

Additionally, the second DC/DC converter 430 may include input terminals 431 and 432 and output terminals 433 and 434, and the input terminals 431 and 432 of the second DC/DC converter 430 may be connected in parallel with the battery 111 to receive the battery voltage, and the output terminals 433 and 434 of the second DC/DC converter 430 may output the second DC module voltage. Additionally, in this specification, the output terminal 433 and 434 of the second DC/DC converter 430 may also be referred to as second DC module output terminals outputting the second DC module voltage.

Additionally, the output terminal 433 and 434 of the second DC/DC converter 430 may be connected in series to the output terminal of the second DC/DC converter 430 included in another battery module, or may be connected to a high voltage load.

The battery 111 may be configured to be connected in parallel with the input terminals 411 and 412 of the inverter 410, the input terminals 421 and 422 of the first DC/DC converter 420, and the input terminals 431 and 432 of the second DC/DC converter 430.

Additionally, the common capacitor 440 may be connected in parallel with the battery 111, and may be configured to be connected in parallel with the input terminals 411 and 412 of the inverter, the input terminals 421 and 422 of the first DC/DC converter, and the input terminals 431 and 432 of the second DC/DC converter.

According to the battery module 110 according to an embodiment of the present disclosure, because one common capacitor may be shared instead of applying individual capacitors to each inverter and each converter element, the volume may be reduced, and since a low-voltage capacitor may be applied, there is an advantage of reducing the production costs.

As described above, according to an embodiment of the present disclosure, the first cooling jacket may be additionally formed in the battery module including the battery, the power conversion module and the busbar, while the busbar may come into close contact with the first cooling jacket and may be formed integrally therewith, so that the cooling performance of the busbar may be improved, thereby reducing the cross-sectional area of the busbar and reducing the costs and weight of the busbar.

Additionally, according to an embodiment of the present disclosure, the first cooling jacket may be added to the battery pack, and the power conversion module and the battery may be in close contact with one surface and the other surface of the first cooling jacket, thereby improving the cooling performance of the battery and the power conversion module.

Additionally, according to an embodiment of the present disclosure, power conversion modules such as an inverter or a converter may be collected into a battery pack and a cooling jacket for cooling the power conversion modules may be disposed in the battery pack, so that the cooling structure may be simplified, and the cooling of the battery may be focused on during charging, thereby securing the charging speed and stability, and reducing the costs.

Additionally, according to an embodiment of the present disclosure, the thermal resistance between the first cooling jacket and the battery may be configured to be smaller than the thermal resistance between the first cooling jacket and the power conversion module, or the flow rate of the cooling medium flowing through the flow path formed in the second cooling jacket and the flow rate of the cooling medium flowing through the flow path formed in the first cooling jacket may be independently controlled, thereby differentially controlling the cooling performance of the power conversion module and the battery.

Although representative example embodiments of the present disclosure have been described in detail above, those skilled in the art will understand that the above-described embodiments may be modified in various manners without departing from the scope of the present disclosure. Therefore, the scope of the present disclosure should not be limited to the described example embodiment and should be determined by the claims described below as well as those equivalent to the claims.

1. A battery pack of a vehicle, comprising:
a plurality of battery modules; and
a first cooling jacket having a flow path formed within the first cooling jacket, wherein a cooling medium flows through the flow path;
wherein each of the plurality of battery modules includes:
a battery;
a power conversion module converting power of the battery; and
a busbar connecting the battery and the power conversion module;
wherein the busbar is in contact with the first cooling jacket and is formed integrally with the first cooling jacket.

2. The battery pack of a vehicle according to claim 1, wherein the first cooling jacket includes an opening through which the busbar passes; and
the busbar is in contact with at least one of a side surface of the opening and an upper surface of the first cooling jacket.

3. The battery pack of a vehicle according to claim 2, wherein the busbar is in contact with the side surface of the opening, extends along the side surface of the opening, and then is bent to contact the upper surface of the first cooling jacket.

4. The battery pack of a vehicle according to claim 3, wherein the busbar includes:
a conductor; and
an insulating medium for insulating the conductor;
wherein at least one of the insulating medium and the side surface of the opening, and the insulating medium and a side surface of the first cooling jacket are in contact with each other via a heat transfer medium.

5. The battery pack of a vehicle according to claim 1, wherein the power conversion module is in contact with one surface of the first cooling jacket, and the battery is in contact with the other surface of the first cooling jacket.

6. The battery pack of a vehicle according to claim 1, further comprising:
a second cooling jacket which is in contact with lower surfaces of the plurality of battery modules and in which a flow path through which the cooling medium flows is internally formed.

7. The battery pack of a vehicle according to claim 6, wherein the battery and the first cooling jacket, the first cooling jacket and the power conversion module, and the second cooling jacket and the plurality of battery modules are in contact with each other via a heat transfer medium.

8. The battery pack of a vehicle according to claim 6, wherein a flow rate of the cooling medium flowing through the flow path formed in the second cooling jacket and a flow rate of the cooling medium flowing through the flow path formed in the first cooling jacket are independently controllable.

9. The battery pack of a vehicle according to claim 1, wherein the power conversion module includes at least one of a DC/DC converter and a DC/AC inverter.

10. A battery pack of a vehicle, comprising:
a plurality of battery modules;
a first cooling jacket having a first flow path formed within the first cooling jacket, wherein a cooling medium flows through the first flow path; and
a second cooling jacket having a flow path formed within the second cooling jacket, wherein the cooling medium flows through the second flow path;
wherein each of the plurality of battery modules includes:
a battery;
a power conversion module for converting power of the battery; and
a busbar connecting the battery and the power conversion module;
wherein the first cooling jacket is provided with an opening through which the busbar passes;
wherein the busbar is in contact with a side surface of the opening and an upper surface of the first cooling jacket;
wherein the power conversion module is in contact with one surface of the first cooling jacket, and the battery is in contact with an other surface of the first cooling jacket; and
wherein the plurality of battery modules are each in contact with an upper surface of the second cooling jacket.
